(19) United States
(12) Patent Application Publication
(10) Pub. No.: US 2017/0024792 A1
(43) Pub. Date: Jan. 26, 2017

(54) METHOD FOR SETTING UP AN ONLINE SHOP

(71) Applicant: Patty's GmbH, Hamburg (DE)

(72) Inventor: Andreas Perschk, Hamburg (DE)

(21) Appl. No.: 15/216,841

(22) Filed: Jul. 22, 2016

(30) Foreign Application Priority Data
Jul. 25, 2015 (DE) 102015112168.9

(51) Int. Cl. G06Q 30/06

(52) U.S. Cl. CPC G06Q 30/0625

(57) ABSTRACT

A method for setting up an online shop is provided. A link is provided to a search engine by a displayable product or product category on the website being formed. When this product or category is selected, the search engine is called up and additional subcategories and/or a predetermined number of retrievable products contained in at least one database are displayed. In a next repeatable step, a product can be selected from the products displayed. A reference code associated with this selected product is read out, which is formed from the image-specific features and the description-specific features of the depiction of the product. With help of the reference code of the selected product, a similarity is determined to the other retrievable products based on their reference codes. Then, a plurality of the products determined to be similar is displayed with at least the readable ordering address for the selected product.

### BACKGROUND

The invention concerns a method for setting up an online shop.

It is customary today to offer products through online shops on the Internet. As a rule, the displaying of the offered products is done after the manual and circumstantial entering of a search term via the keyboard of the data processing system. The products indicated thereafter can be selected and represented with further information on the display device. However, an online shop facilitates the buying of products by showing on the basis of an inquiry a multitude of corresponding offers coming under the inquiry term, which can then be selected and acquired with the click of a mouse.

It is also known that the displaying of the products offered has a button through which similar products are displayed. But the similar products are a limited assortment of products which are available through the selected online shop. It is therefore possible that certain products will not be found or displayed, even though they have a great similarity to the initially selected product. Often, as well, this search for similar products can only be carried out one time.

The providing of such an online shop is relative time-consuming, since the available offers need to be categorized in order to be displayed on the basis of a corresponding inquiry. The number of products displayed is therefore oftentimes limited.

The problem which the invention proposes to solve is to create a method for setting up an online shop, with which a comprehensive online shop can be quickly constructed. In particular, the user of the online shop should have access to a not previously limited number of products. In particular, it should be possible to display nearly all offers available on the Internet in accordance with the search inquiry.

### SUMMARY

According to the invention, it is proposed that a link is provided to a search engine by a displayable product or a displayable product category on the website of the online shop being formed, that when this product or this product category is selected on this website the search engine is called up and additional subcategories and/or a predetermined number of retrievable products contained in at least one database are displayed, that in a next repeatable step a product can be selected from the products displayed, that a reference code associated with this selected product is read out, which is formed from the image-specific features and the description-specific features of the depiction of the product, that with the help of the reference code of the selected product a similarity is determined to the other retrievable products based on their reference codes, and that then a plurality of the products determined to be similar is displayed, wherein the displaying of the determined products contains at least the readable ordering address for the selected product. By selecting the displayed product on the website of the online shop, the user obtains access to a search engine with which the entire Internet can be searched.

Accordingly, it is only necessary to establish the starting point for the setting up of a comprehensive online shop by an avatar image of the sought product or the sought product group. This image can be an artificially generated picture, or also a real picture of a product or the like. The subsequent image analysis then occurs by means of the similarity to the displayed picture.

Thanks to the invention it is possible to build a new online shop within a few hours so that the entire worldwide offering in the desired product categories is already extensively displayed and can be purchased or sold. By selecting an image as avatar, the starting point is established from which the similarity analysis is launched. All products available on the Internet are thus evaluated by means of similarity and displayed.

According to the invention, a data record of each offer found is created in the form of a reference code. This data record contains values on pictorial features and on conceptual features of the displayed product. The reference code can be composed of numerical or alphanumerical characters. The reference code created for the selected product is then compared with the other reference codes deposited in the search engine. This is possible because the visible and readable features are characterized by the reference code. Therefore, a comparison of images can be done only on the basis of this reference code. The advantage is that only the reference codes need to be compared. This can be done very fast and with a high percentage of hits.

In particular, it is provided that, when comparing the reference codes, a significance of the similarity is determined, and the displaying of the products so determined occurs in order of significance. In this way, at first the actually very similar products are displayed, whose similarity to the manually selected product steadily diminishes. It is also possible in this way to display products apparently not similar to the human eye, since the reference code cannot evaluate the pictorial features. This can be remedied by checking, before displaying the respective product, to make sure that it still lies within at least the initially selected product gallery.

Finally, by the selection of a product, all available offers are displayed in the order of the significance of the similarity. Of course, not all offers are displayed at once on the data processing system. The user would no longer be able to make a sensible selection in that case.

Instead, it is provided that a predetermined number of the products determined from the similar products are displayed in accordance with the similarity. The number can be tailored to the display capability of the display device being used. Thus, the displayed number can comprise, for example, around 60 offers, which can still be properly viewed by scrolling up and down the screen display.

It is possible for a displaying of similar products to occur only when a predetermined portion of the retrievable products have been compared with the selected product. Also, a displaying of similar products can occur only when a predetermined number of similar products have been found. With this provision, the search remains manageable.

Once the first displayed number of offers has been looked at, the next number can be displayed. It is therefore provided that the next predetermined number of products found is displayed after reaching the last of the displayed products. This can be done by an additional command or by a downward scrolling with the mouse cursor.

The user in the course of the search can select a variety of products about which he wishes to obtain further information. In order to make the search manageable, it can be provided that the products selected manually for the display are saved in memory and/or displayed. The user can then quickly check his previous selection.

It can be provided that the user can select an offer and then continue his search in the products already displayed or yet to be displayed. It is also possible to interrupt the former search with the selection and to begin the further searching with this selected product. The products will then be resorted by the search engine and displayed according to the significance. In this way, the user can come close to his last searched desired product relatively quickly.

The formation of the reference code is basically arbitrary. However, it is advisable for the reference code to contain the image-specific features and the description-specific features in order to preserve a standardized format by which the comparing of the images of the retrievable products can be done quickly and reliably. In this way, the search can be done quickly and efficiently. In particular, it is possible to give a weight to different pictorial or conceptual features so that the search remains accurate. The reference code furthermore contains a link to the offer itself, so that by selecting the reference code it is possible to make a connection to the offer in order to display it.

According to a preferred embodiment, the manual selecting is done by clicking on and/or touching the pictorial representation of the displayed product or product category on the display device. The search is therefore done only with the help of the manual entry device, such as the mouse or the touch pad or touch screen. The manual entering of terms by keyboard is eliminated. The search can therefore be done very conveniently and intuitively.

For a comprehensive search, it is therefore only necessary to detect the offers and create the reference code. The creating of the reference code can be done automatically with the help of electronic image processing and text recognition. It is therefore provided that the creation of the reference code of the retrievable products is done independently of a search, the reference code is saved in a metadatabase, and only the metadatabase is searched by the search engine when determining the similarity to a selected product. This metadatabase is accordingly filled in ongoing manner with the reference codes of the products basically retrievable on the Internet. All products would then be in fact detected and characterized by a reference code at one time or another. Even so, this very large volume of data remains manageable, since only alphanumeric characters need to be compared. Even when there are very many products, such a search is fast, comprehensive, and accurate.

The image analysis for the search for similar images is done on the basis of image descriptions previously calculated. The so determined image descriptors enable a rapid comparison of images, so that the results of the search are quickly obtained. The image descriptors describe the image in a multidimensional data space. The determination of the position of the image descriptor in the data space enables a ranking of the images reviewed. The image descriptors are contained in the metadata record and enable a search by significance of similarity. It is possible to determine an order such that the most similar products are displayed first. The image descriptor contains only image information. However, text features can be added.

According to another embodiment of the invention, it is provided that the pictorial representation and/or its description of the product or the product category selected for the link for the individual display on the website of the online shop can be altered without altering the assigned reference code. Thus, the operator of the new online shop can organize his presentation for the offered search based on individual perspectives. Ultimately, it is not recognizable to the user that the operator is making use of the search engine according to the invention.

Upon selecting and purchasing a displayed product, at least one additional code can be added to the product-specific code by which the search engine or the online shop called up can be identified. In this way, the offerer, the online shop operator, and the operator of the search engine can profit from the product found and purchased in this way.

### BRIEF DESCRIPTION OF THE DRAWINGS

The invention shall be explained more closely below with the aid of the schematic drawing. There are shown:

FIG. 1 a diagram of the method according to the invention and

FIG. 2 the display of a specific offer.

### DETAILED DESCRIPTION

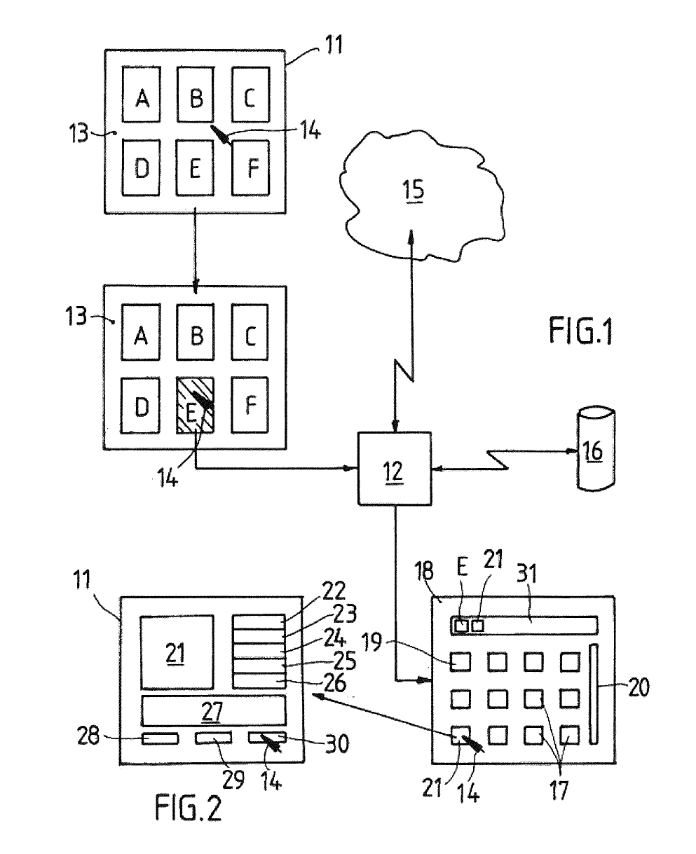

FIG. 1 shows a display device 11, which is connected to a not otherwise depicted data processing system 12 of the user. On the display device, which can be a monitor screen in particular, there are shown for example six products A-F on a start page 13, being representative of the online shop being set up or the products being purchased. Basically, it is possible and also advisable to display more than six products.

Furthermore, one notices on the screen 11 an operating pointer 14, which can be operated by the user, for example, with a computer mouse. For example, the user points with the operating pointer 14 at the product E and selects it, for example, by clicking or double clicking on the computer mouse.

But basically the operating pointer can also be fashioned so that the viewing direction of the user and thus the product being considered by him can be determined by means of glasses which are worn. The clicking on the respective product can then be done by simply a longer eye contact with this product.

The image of the product E, i.e., the pictorial content, is subjected by the data processing system 12 or a program running on it or a program called up by it or running on a server connected to the data processing system 12 to an image analysis so that similar products or images are found. These images can be retrieved from the World Wide Web 15 or from a local database 16. The similar images or products 17 so found are displayed on a new page 18 of the screen 11 in place of the start page 13. It can be provided that the last actively selected product 19, corresponding to the product avatar E after the first search, is displayed and remains on the screen 11, for example, at upper left in the table of displayed products 17. Thus, the user always has in view the product which he last selected.

On this page 18 only a first number of, for example, twelve products are displayed, being similar to the selected product E. For example, at the right screen margin there is indicated a scrollbar 20, by means of which the user can display further products or images of products of the same search. The last actively selected image 19 preferably always remains in the same place on the screen. In this way, the user can quickly navigate through the multitude of offers with only the operating pointer.

If the user has found a suitable product 21 during this search, he can select it in usual manner by activating the operating pointer. The product 21 shown in FIG. 2 then appears on the screen 11 in larger representation. This representation contains all necessary information about the product, such as manufacturer or brand 22, the offerer 23, the purchase price 24, the size 25, the color 26, as well as a description field 27. Especially when indicating the size or color, the fields 25, 26 can be buttons by which the displayed product can be modified to suit the needs of the user. This is especially expedient in the case of fashion or apparel articles.

Moreover, there are another two or three fields in this display of the selected product. In one field 28, the selected product 21 can be purchased. After activating this field, the familiar purchasing process occurs with the offerer. By activating the field 29, this product 21 can be stored.

With the field 30, a new search for similarity can be started with this product 21 as the starting point. The aforementioned steps then occur for the displaying of similar products 17 on the screen. The product 19 shown upper left is then the last selected product 21.

For a better overview, furthermore, it can be provided that all actively selected products remain displayed on another scrollbar, for example, in an upper horizontal bar 31. Accordingly, the images E and 21 are displayed in this sequence. The user can thus better continue with his search. It is also possible to return to an already selected product 21, for example, if the following searches were not productive.

Thus, on the whole, an online shop of any desired size can be set up by simply activating the operating pointer 14. The user need only move from one image to the next until he has found a desired product. He can then select it and purchase it in the usual way.

It is not necessary to enter any text in this process. Instead, the search is done only by means of an image.

1. A method for setting up an online shop, wherein a link is provided to a search engine by a displayable product (A, B, C, D, E, F) or a displayable product category (A, B, C, D, E, F) on the website being formed, that when this product (E) or this product category is selected on this website the search engine is called up and additional subcategories and/or a predetermined number of retrievable products (17) contained in at least one database (15, 16) are displayed, that in a next repeatable step a product (21) can be selected from the products (17) displayed, that a reference code associated with this selected product (21) is read out, which is formed from the image-specific features and the description-specific features of the depiction of the product, that with the help of the reference code of the selected product a similarity is determined to the other retrievable products based on their reference codes, and that then a plurality of the products determined to be similar is displayed, wherein the displaying of the determined products contains at least the readable ordering address for the selected product.

2. A method according to claim 1, wherein a predetermined number of the products determined from the similar products are displayed in accordance with the similarity.

3. A method according to claim 2, wherein the next predetermined number of products found according to similarity are displayed after reaching the last of the displayed products.

4. A method according to claim 3, wherein, when comparing the reference codes, a significance of the similarity is determined, and the displaying of the products so determined occurs in order of significance.

5. A method according to claims 4, wherein the products (E, 21) selected manually for the display are saved in memory and/or displayed.

6. A method according to claim 5, wherein the reference code contains the image-specific features and the description-specific features in predetermined place-holder locations in order to preserve a standardized format, by which the comparing of the images of the retrievable products can be done quickly and reliably.

7. A method according to claims 6, wherein the manual selecting is done by clicking on and/or touching the pictorial representation of the displayed product or product category on the display device.

8. A method according to claim 7, wherein the creation of the reference code of the retrievable products is done independently of a search, the reference code is saved in a metadatabase of the search engine, and only the metadatabase is searched by the search engine when determining the similarity to a selected product.

9. A method according to claim 8, wherein the pictorial representation and/or its description of the product or the product category selected for the link for the individual display on the website of the online shop can be altered without altering the assigned reference code.

10. A method according to claim 9, wherein, upon selecting and purchasing a displayed product, at least one additional code is added to the product-specific code, by which the search engine or the online shop called up can be identified.

11. A method according to claim 1, wherein the next predetermined number of products found according to similarity are displayed after reaching the last of the displayed products.

12. A method according to claim 1, wherein, when comparing the reference codes, a significance of the similarity is determined, and the displaying of the products so determined occurs in order of significance.

13. A method according to claims 1, wherein the products (E, 21) selected manually for the display are saved in memory and/or displayed.

14. A method according to claim 1, wherein the reference code contains the image-specific features and the description-specific features in predetermined place-holder locations in order to preserve a standardized format, by which the comparing of the images of the retrievable products can be done quickly and reliably.

15. A method according to claims 1, wherein the manual selecting is done by clicking on and/or touching the pictorial representation of the displayed product or product category on the display device.

16. A method according to claim 1, wherein the creation of the reference code of the retrievable products is done independently of a search, the reference code is saved in a metadatabase of the search engine, and only the metadatabase is searched by the search engine when determining the similarity to a selected product.

17. A method according to claim 1, wherein the pictorial representation and/or its description of the product or the product category selected for the link for the individual display on the website of the online shop can be altered without altering the assigned reference code.

18. A method according to claim 1, wherein, upon selecting and purchasing a displayed product, at least one additional code is added to the product-specific code, by which the search engine or the online shop called up can be identified.
